(19) United States
(12) Patent Application Publication
(10) Pub. No.: US 2011/0227692 A1
(43) Pub. Date: Sep. 22, 2011

(54) ROCKER SWITCH UNIT WITH FUSE

(76) Inventor: Wolfgang SCHWABENLAND, Hanau (DE)

(21) Appl. No.: 13/118,946

(22) Filed: May 31, 2011

Related U.S. Application Data
(63) Continuation of application No. PCT/EP2008/068009, filed on Dec. 19, 2008.

(51) Int. Cl. H01H 85/02

(52) U.S. Cl. 337/10

(57) ABSTRACT

It is disclosed a rocker switch unit with fuse, the unit comprising a housing; a rocker switch lodged pivotally in the housing; at least a fuse lodged in the housing and at least two connection elements for connecting the rocker switch unit with an external element, wherein the two connection elements are connected to each other by the fuse, when rocker switch is in an ON-position. According to the invention the housing provides at least one blind hole for accommodating the fuse, wherein one end of the fuse serves as a first connection element for connecting the rocker switch unit with the external element. The rocker switch unit as discloses herein can be used in any apparatus, in a network filter or as IEC entry plug.

### RELATED APPLICATIONS

The present application is a continuation of international application PCT/EP2008/068009 (WO2010069392), filed Dec. 19, 2008, the content of which is hereby incorporated by reference.

### FIELD OF THE INVENTION

The present invention concerns a rocker switch unit with fuse according to the independent claim. Advantageous embodiments are given in the dependent claims. The inventive rocker switch unit as discloses herein can be used in any apparatus, in a network filter or as IEC entry plug.

### DESCRIPTION OF RELATED ART

Switches with a fuse are known prevalent in the prior art. Examples of such embodiments are given.

FR2499761 discloses a bipolar switch provided with a fuse which comprises a modular dimensions body presenting two housings for the bipolar switch and a housing including a fuse holder which can have different dimensions. Two contacts face two terminals used for connection to a neutral feeder line wire. Second feeder wire (phase wire) is connected to the terminal and to the terminal of the fuse holder.

FR2431762 discloses a circuit breaker with selecting prong presenting a cavity used for housing a fuse cartridge. This circuit breaker is intended to be placed on phase conductors of single-phase installations.

EP0690527 discloses a connector for a single phase cable which is used with a power supply network and has a plastic housing with removable covers. The top side of the housing has flat conductors that engage projecting finger contacts, with forked ends that can latch onto conductors. Within base are screw terminals that receive the cables. A fuse is used to link cable ends to the conductors. A removable cover is provided on one side of the housing allowing an easy access to the HRC fuse.

U.S. Pat. No. 3,800,259 discloses a housing which has a pair of spaced first and second contact members for respectively being interconnected in a desired electric circuit whereby the electrical circuit will not be completed unless the contact members are electrically interconnected together. A manually movable fuse member is carried by the housing and has one operating position relative to the housing where the fuse member makes electrical contact between the contact members and through the fuse part thereof so that the circuit will not only be completed by the fuse member, but also the circuit will be fused by the fused member. The fuse member when moved to another operating position thereof relative to the housing will break electrical contact between the contact members to open the circuit whereby the fuse member also acts as a manually operable switch for the electrical circuit.

U.S. Pat. No. 6,734,580 relates to a fused switch unit with a housing and switching rocker, which is mounted in the housing of the fused switch unit such that it can pivot to and fro between a switched-on positon and a switched-off position. The fused switch unit has apparatuses for a monitoring circuit and an indication for monitoring the serviceability of a fuse link, with the indication being arranged in the switching rocker. The indication is preferably an optical indication.

FR2191234 discloses a switch with a body, in which a fuse is inserted. The body has to be removed in order to change the body. DE9403879U discloses a similar embodiment.

U.S. Pat. No. 4,298,854 discloses a combined cartridge fuse holder and switch employs a novel switching mechanism including a pair of spaced bars arranged in a first plane and positioned adjacent an inclined ramp. A contact pin is mounted in a switch arm, which in turn is pivotally mounted so that the pin can be moved from an OFF position in which the pin rests on the inclined ramp to an ON position resting on and bridging the contact bars. One of the contact bars is electrically coupled to a first terminal while the other of the contact bars is electrically coupled through a fuse to a second terminal.

The disadvantage of these switches is that too many mechanical parts are involved. Too many mechanical parts lead not only to higher production costs per part, but increase the danger of failure of each of these parts. Additionally, especially where the fuse is inside the switch the fuse can not easily be replaced. Another drawback of these switching units comes from the fact that many of them can not be removed as an entire unit, but are connected to the apparatus. In case of failure of the switching unit it is not easy to be removed in order to repair the switch. Another drawback comes from the fact the switches are too big and space consuming.

### BRIEF SUMMARY OF THE INVENTION

It is another aim to produce a rocker switching unit which avoids the drawbacks of the prior art.

It is therefore the aim to produce a switching unit with less mechanical parts than known in the prior art and with a switch body which is simpler than the embodiments known in the prior art.

It is another aim to produce a switching unit which can easily be removed from any apparatus to change the fuse or the entire unit.

It is another aim to produce a switching unit which less space consuming than the models known from the prior art.

According to the invention, these aims are achieved by means of a rocker switch unit according to the preamble of the independent claim characterized in that the housing provides at least one blind hole for accommodating the fuse, wherein one end of the fuse serves as a first connection element for connecting the rocker switch unit with the external element.

Advantageous embodiments are given in the dependent claims.

The fuse can advantageous be held inside the blind hole by a spring and a fuse holder. Below the rocker switch can be provided a base, which is geared on two sides by a spring and a ball bearing, the ball bearing switches a switch connection element to connect two connector elements, when rocker switch is in the ON-position.

The housing provides on the upper side, where the rocker switch is pivotally lodged, on each lateral side two lateral walls, which are separated by a slot, whereby the two walls are connected separately to the lower part of the housing. The rocker switch is pivoting fastened on two opposed lateral sides to the two inner walls of the housing by means of knobs, whereby the inner walls have corresponding circular apertures. Assembly of the inner parts including the connecting elements, the base and switch can thus easy be done, because the switch is removable from the top.

Below the switch on top of the base there can be arranged illumination means such as a light or an LED to prove the good functioning of the unit and indicating when the switch is in the ON-position and can be seen in the dark.

The advantages of the inventive switching unit comes from the fact that from the housing surrounding the rocker switch such that the rocker switch gives essentially the size of the housing and the entire unit. From the outer side during normal operation the fuses can not be seen. The user does not have to care these fuses. However, the unit can be pulled of from an apparatus easily to change the fuse or even the entire unit, if necessary. This can be described in a manual of the apparatus. The rocker switch unit as discloses herein can be used in any apparatus, in a network filter or as IEC entry plug.

### BRIEF DESCRIPTION OF THE DRAWINGS

The invention will be better understood with the aid of the description of an embodiment given by way of example and illustrated by the figures, in which:

FIG. 1a, b shows a general view from two sides of the rocker switch unit according to the invention;

FIG. 1c shows a view from below of the rocker switch unit according to the invention;

FIG. 2a shows a section according to the section A-A in the FIG. 1c through the inventive rocker switch unit;

FIG. 2b shows a section according to the section B-B in the FIG. 1c through the inventive rocker switch unit;

FIG. 3a, b, c show various view of the housing of the rocker switch unit;

FIG. 4 shows an embodiment of a light base;

FIG. 5 shows an embodiment of a fuse connector;

FIG. 6 shows a switch connection element according to the invention;

FIG. 7 shows a first connection element;

FIG. 8 shows an embodiment of the rocker switch;

FIG. 9 shows a second connection element and

FIG. 10 shows a cut through a spring within the fuse holder.

### DETAILED DESCRIPTION OF POSSIBLE EMBODIMENTS OF THE INVENTION

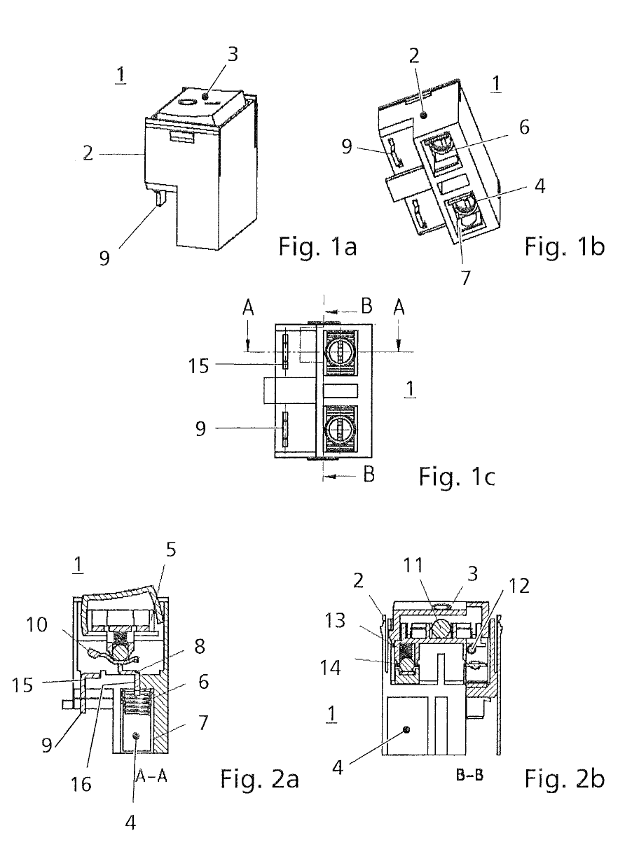

FIG. 1a shows a general view from two sides of the inventive rocker switch unit 1 with a switch body or housing 2. On top of the rocker switch unit 1 is provided a switch or rocker switch 3 having two positions, one ON-position and one OFF-position. FIG. 1b shows a second view of the inventive rocker switch unit 1 from the bottom of the unit. On the bottom of the inventive unit 1 are provided two blind holes 4 in which the fuse (not shown) can be entered. On end of the fuse is connected in the inner side of the blind hole 4 by means of a spring 6, while the second side serves as first connecting element of the unit 1 for connecting the rocker switch unit 1 with the external element, when the switch is in use. As seen in FIG. 1b second connecting elements 9 are provided on the lower part of the bottom of the unit 1 for connecting the rocker switch unit 1 with the external element.

The housing 2 of unit 1 is formed with a step at the bottom, wherein in the rear side of the step there is arrange the blind holes 4 and on the step itself the connecting elements 9 are located. The housing 2 consists of a single piece accommodating all essential part of the unit 1. The size of the unit 1 correspondent essentially to the size of the switch 3 itself, which representation a great advantage of the unit 1. FIG. 1c shows a view from below of the inventive rocker switch unit 1, in which the blind holes 4 and the second connecting elements 9 can be seen.

To better understand the separate elements of the unit 1, FIG. 2a provides a section according to the section A-A in the FIG. 1c through the unit 1 and FIG. 2b shows a section according to the section B-B in the FIG. 1c through the inventive rocker switch unit 1.

As shown in FIG. 2a, b below the switch 3 (detail see FIG. 8) inside the housing 2 there is a light base 5 (FIG. 4). The light base 5 transmits the movements of the switch and connects/disconnects the switching elements according to the ON- or OFF-position of the switch 3 via a switch connector 10. The light base 5 is geared on each side with a spring 13 and a ball bearing 14, which contacts and leads the switch connector 10. For the reason, two projections are provided on the lower side of the base 5, in which the spring is kept. To connect the outer apparatus connecting elements 8 (FIG. 9) and 9 (FIG. 7) are located inside the housing 2 on the inner bottom of said housing 2 and extend through the bottom by slits 15, 16.

The connection element 8 shown in detail in FIG. 7 is connected by two horns to the switching elements 10 (FIG. 6), which has two corresponding recesses on each side in his middle section. The middle section of the connection element 8 lies on the internal bottom of the housing 2 and one end extends perpendicular to and is connected with the switching element 10 and the other end extends perpendicular in the other direction through slits 16 inside the blind hole 4. This end of the connection element 8 connects one end of the fuse (not shown) by means of the spring 6. The second connection element 9 has the form of on L and is lodged by the lower part of the L on the bottom inside the housing and the other part of the L is available on the outer side through the slits 15 as seen in FIG. 1a, b and FIG. 2a. The light base 5 which transmits the movements of the switch 3 connects/disconnects the switching elements according to the ON- or OFF-position of the switch 3 via the switch connector 10 and connects/disconnects both connection elements 8, 9. For fuses in both blind holes 4 there are connecting elements 8, 9 with a switching connector 10 arranged next to each other. For this reason, the light base 5 is geared on each side on a ball bearing 14 having a spring 13.

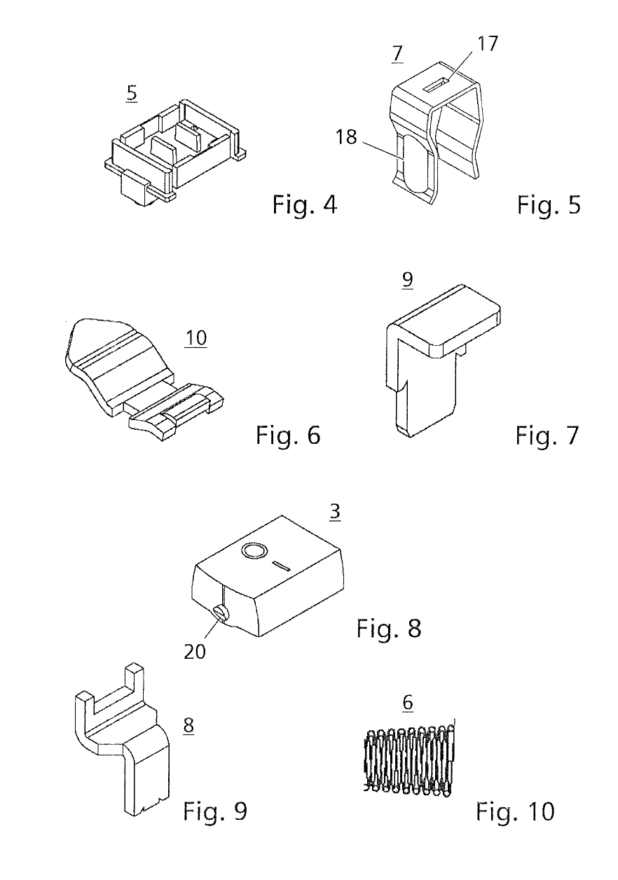

Inside of each the blind hole 4 the spring 6 and a fuse connector 7 is foreseen. FIG. 10 shows a cut through the spring 6 within the fuse connector 7 and FIG. 5 shows an embodiment of a fuse connector 7. The fuse connector 7 has a form of a turned U. The top is provided again with a slit 17 (FIG. 5), through which extends one end of the connection element 8 (see FIG. 2a). This end of the connection element is connected to the spring 6. In one leg of the fuse connector 7 is present an aperture 18, which accommodates and holds the fuse. Both spring 6 and depressions in both legs hold the fuse in place. Due to flexibility of the fuse connector 7, the fuse can easily be removed or replaced. The spring 6 shown in FIG. 10 has two different diameters on both sides; it can thus be introduced easily into the fuse connector 7 and the blind hole 4.

In addition as seen in FIG. 2b below the switch 3 on top of the light base 5 there are illumination means such as a light 11 or an LED arranged to prove the good functioning of the unit and indicating when the switch is in the ON-position and can be seen in the dark. The resistor 12 is connected to the light 11.

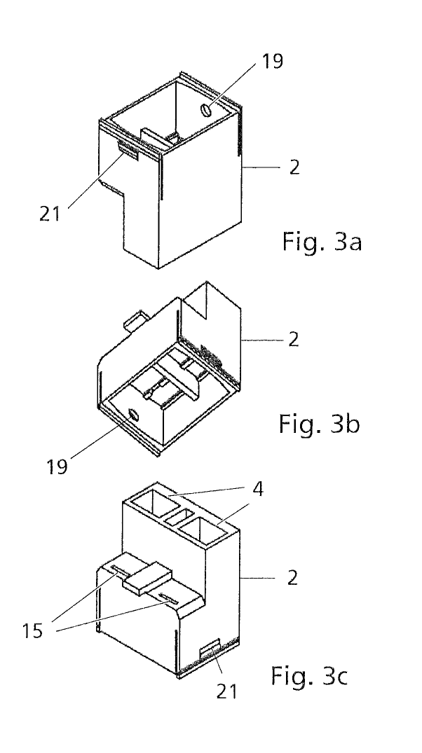

FIG. 3a, b, c show various view of the housing 2 of the switch unit 1. According to the invention the housing 2 consists of a single piece. The housing 2 provides on the upper side, where the switch 3 is lodged, on each lateral side two lateral walls, which are separated by a slot, whereby the two walls are connected separately to the lower the lower side of the housing. The switch 3 is pivotally fastened on two opposed lateral sides to the two inner walls of the housing 2 by means of knobs 20. The inner walls have corresponding circular apertures 19 to allow the pivoting. Assembly of the inner parts including the connecting elements 8, 9, the base 5 and switch 3 can thus easy be done. The outer walls have on the outer side each a clipping element 21 for fastening the unit 1 to any apparatus. Assembly of the inner parts of the unit 1 including the connecting elements, the base and switch can thus easy be done, because the switch is removable from the top.

The advantages of the inventive unit 1 is that from the housing surrounding the rocker switch 3 such that the rocker switch 3 gives essentially the size of the housing and the entire unit 1. From the outer side during normal operation the fuses can not be seen. Any other does not have to care these fuses. However, the unit 1 can be pulled of from an apparatus easily to change the fuse or even the entire unit 1, if necessary. This can be described in a manual of the apparatus. The rocker switch unit 1 as discloses herein can be used in any apparatus, in a network filter or as IEC entry plug.

### REFERENCE NUMBERS

1 Rocker switch unit
2 Housing, switch body
3 Rocker switch, switch knob
4 Blind hole in the Housing 2
5 Light base
6 Spring for fuse connector 7
7 Fuse connector
8 Connecting element
9 Connecting element
10 Switch connector
11 Light
12 Resistor
13 Spring in the rocker switch unit 1
14 Ball bearing
15 Slit in housing 2 for connecting element 9
16 Slit in housing 2 for connecting element 8
17 Slit in fuse connector 7
18 Aperture
19 Circular aperture
20 Knops
21 Clipping element

1. Rocker switch unit with fuse comprising a housing;
a rocker switch lodged pivotally in the housing having an ON- and an OFF-position;
at least a fuse lodged in the housing;
at least two, a first and second connection elements for connecting the rocker switch unit with an external element, wherein the two connection elements are connected to each other by the fuse, when rocker switch is in the ON-position, and both connection elements are disconnected, when the rocker switch in the OFF-position, wherein
the housing provides at least one blind hole for accommodating the fuse, and wherein one end of the fuse serves as a first connection element for connecting the rocker switch unit with the external element.

2. Rocker switch unit according to claim 1, wherein in the at least one blind hole there is provides a spring to connect to the second end of the fuse.

3. Rocker switch unit according to claim 1, wherein in the at least one blind hole there is arranged a fuse holder.

4. Rocker switch unit according to claim 1, wherein in the housing there are two blind holes next two each other for accommodating two fuses and two connection elements for each fuse.

5. Rocker switch unit according to claim 1, wherein the housing consists of a single piece accommodating on a first side the rocker switch and on a second side opposite to the first side the at least one fuse in the blind hole.

6. Rocker switch unit according to claim 1, wherein the housing is formed with a step, wherein on the step there is arranged the second connection element.

7. Rocker switch unit according to claim 1, wherein the housing is formed with a step, wherein in the rear side of the step there is arrange the at least one blind hole.

8. Rocker switch unit according to claim 1, wherein one connection element has the form of an L and is lodged with the lower part of the L on the bottom inside the housing and the other part of the L is available on the outer side through a slit inside the housing for connecting the rocker switch unit with the external element.

9. Rocker switch unit according to claim 1, wherein the second end of the fuse is connected by means of a connection element inside the blind hole, which extends through an internal slit to the inner side of the housing.

10. Rocker switch unit according to claim 1, wherein below the rocker switch is provided a base, which is geared on each side by a spring and a ball bearing, the ball bearing switches a switch connection element to connect two connector elements, when rocker switch is in the ON-position.

11. Rocker switch unit according to claim 1, wherein the housing provides on the upper side, where the rocker switch is pivotally lodged, on each lateral side two lateral walls, which are separated by a slot, whereby the two walls are connected separately to the lower part of the housing.

12. Rocker switch unit according to claim 11, wherein the rocker switch is pivoting fastened on two opposed lateral sides to the two inner walls of the housing by means of knobs, whereby the inner walls have corresponding circular apertures.

13. Rocker switch unit according to claim 1, wherein the rocker switch unit has lateral clipping elements on the housing to connect the unit to an external element.

14. Rocker switch unit according to claim 1, wherein below the rocker switch there are illumination means arranged.

15. Rocker switch unit according to claim 1, wherein the housing surrounds the rocker switch such that the rocker switch gives essentially the size of the housing.

16. The use of a rocker switch unit according to claim 1 used in an apparatus, in a network filter or as IEC entry plug.
